(19) United States
(12) Patent Application Publication
(10) Pub. No.: US 2024/0278863 A1
(43) Pub. Date: Aug. 22, 2024

(54) Shock-absorbing tube structure for a bicycle seat

(71) Applicant: S.D. COMPONENTS CO., LTD., Fuxing Township (TW)

(72) Inventor: PAO-KUNG WU, Fuxing Township (TW)

(21) Appl. No.: 18/093,288

(22) Filed: Feb. 19, 2023

(51) Int. Cl. B62J 1/06; B62J 1/08

(52) U.S. Cl. CPC B62J 1/06; B62J 1/08

(57) ABSTRACT

A shock-absorbing tube structure for a bicycle seat includes: a seat post, a shock-absorbing unit, a saddle set, an arm set and an actuating rod, wherein the seat post has a post member, a lower saddle clamp on the top of the post member. The shock-absorbing unit includes a fixed pole integrated in the post member, a piston pole is connected above the fixed pole through an elastic member, and the pivoting groove is arranged on the top of the piston pole, the saddle set has an upper saddle clamp, the arm set has a first arm and a second arm, a first pivoting portion is formed below the actuating rod, and a second pivoting portion is formed above

### BACKGROUND OF INVENTION

### Field of Invention

The present invention relates to a shock-absorbing tube structure for a bicycle seat, and more particularly to a shock-absorbing tube structure for a post member of a bicycle.

### Description of the Related Art

At present, conventional bicycle saddles/seats are mostly equipped with a post member inserted in the seat tube. The upper end of the seat tube is open and has a quick release component. Through the combination of the post member and the seat tube, the post member can be raised and lowered in the seat tube of the frame to adjust the height of the seat cushion. After adjustment, the post member can be positioned by tightening the quick release components. However, since the conventional post member does not have the function of cushioning and shock absorption, so when the bicycle travels on an uneven road surface, it will inevitably cause the rider to feel uncomfortable due to the vibration of the vehicle.

Therefore, it is desirable to provide a a shock-absorbing tube structure for a bicycle seat to mitigate and/or obviate the aforementioned problems.

### SUMMARY OF THE INVENTION

An objective of present invention is to provide a shock-absorbing tube structure for a bicycle seat which is capable of improving the above-mention problems.
In order to achieve the above mentioned objective, a shock-absorbing tube structure for a bicycle seat has: a seat post, a shock-absorbing unit, a saddle set, a linkage arm set, and an actuating rod. The seat post has a post member with a lower assembling base at a top end. The shock-absorbing unit has a fixed pole lockable in the post member, an elastic member sleeved onto a free end of the fixed pole and sleeved onto a piston pole at another end, another end of the piston pole having a pivoting groove for connecting to an end of the actuating rod. The saddle set has a lower saddle clamp for assembling a saddle. The linkage arm set has a first arm respectively pivoted onto a front end of the lower saddle clamp and a front end of the lower assembling base, and a second arm respectively pivoted onto a rear end of the lower saddle clamp and a rear end of the lower assembling base, to couple the lower saddle clamp and the lower assembling base via the first arm and the second arm and providing a containment space for the actuating rod. The actuating rod has a first pivoting portion and a second pivoting portion, the first pivoting portion is inserted into the post member and the pivoting groove and pivoted with the piston pole, and the second pivoting portion is pivoted with the lower saddle clamp and the second arm.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combined view of a preferred embodiment according to the present invention.

FIG. 2 is a three-dimensional exploded view of the preferred embodiment according to the present invention.

FIG. 3 is a cross-sectional view of the preferred embodiment according to the present invention.

FIG. 4 is an enlarged cross-sectional view of the preferred embodiment according to the present invention.

FIG. 5 is schematic drawing showing action movement of the preferred embodiment according to the present invention.

### DETAILED DESCRIPTION OF THE PREFERRED EMBODIMENT

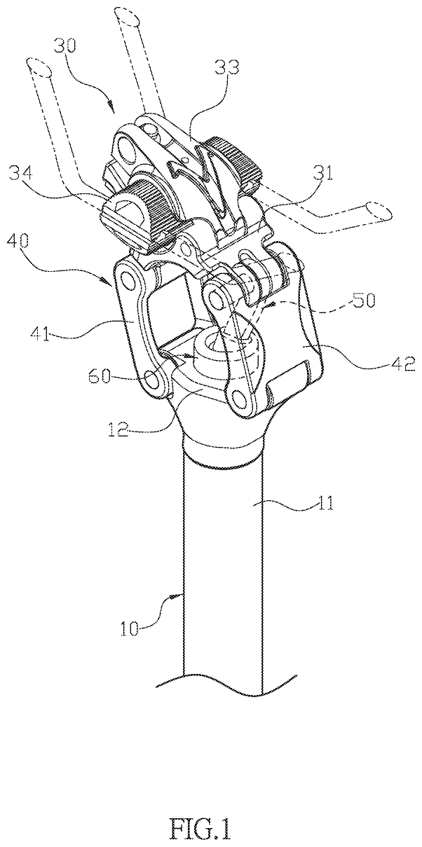

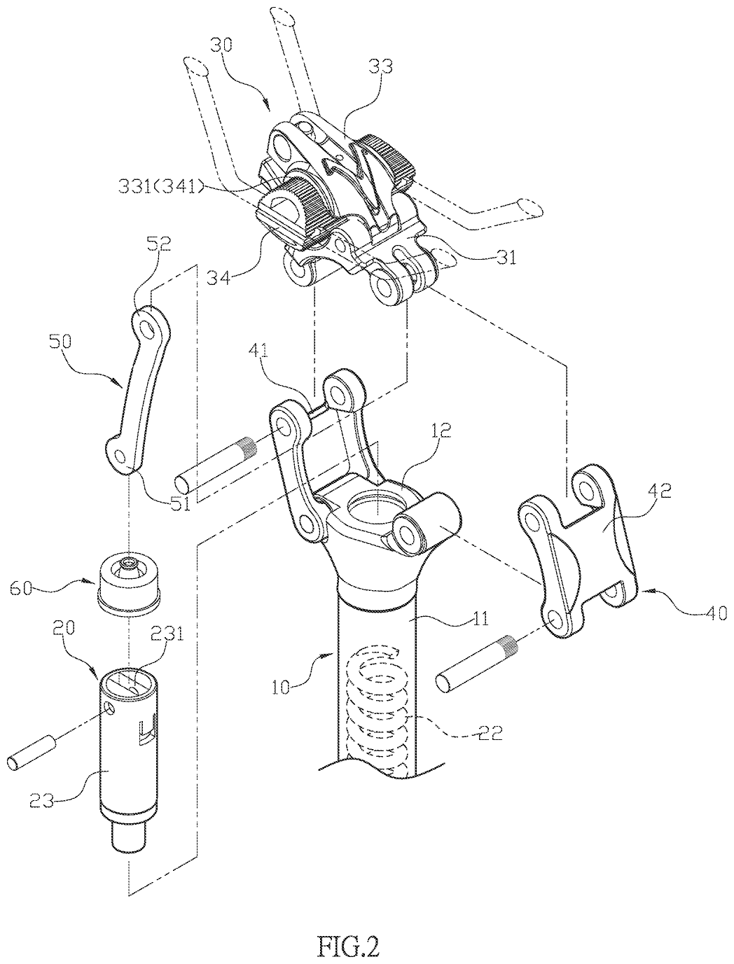

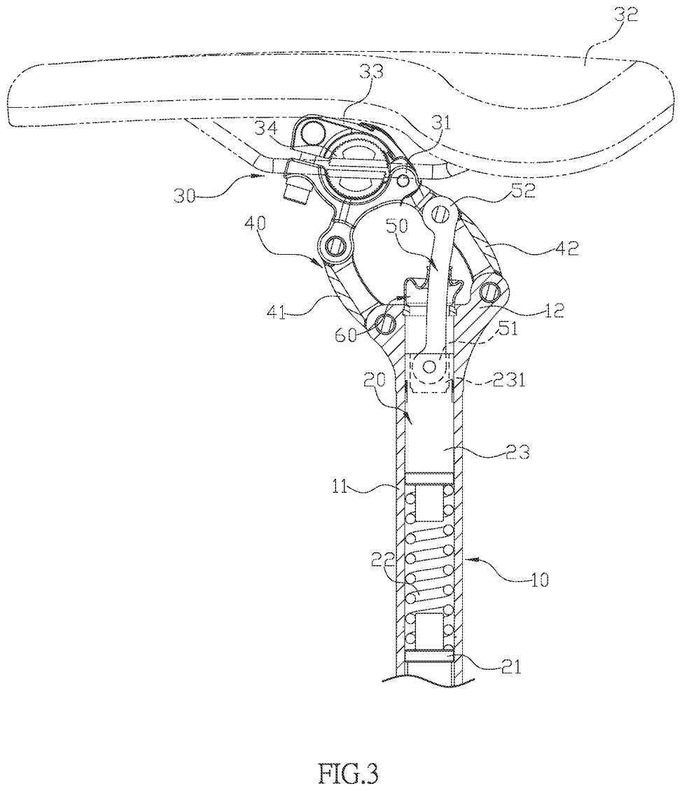

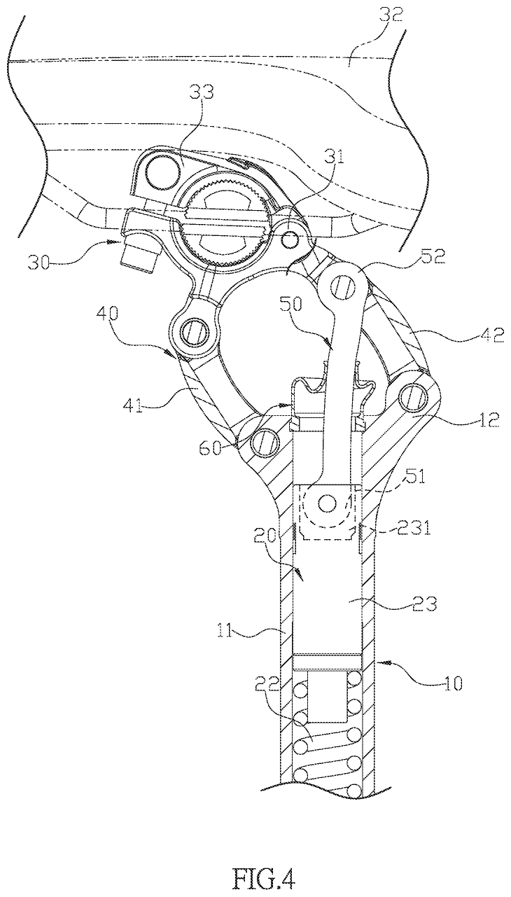

First, please refer to FIG. 1-FIG. 4. A shock-absorbing tube structure for a bicycle seat comprises: a seat post 10, a shock-absorbing unit 20, a saddle set 30, an arm set 40 and an actuating rod 50. The seat post 10 has a post member 11 with a lower assembling base 12 at a top end of the post member 11. The shock-absorbing unit 20 has a fixed pole 21 lockable in the post member 11, an elastic member 22 is sleeved onto a free end of the fixed pole 21 and sleeved onto a piston pole 23, and another end of the piston pole 23 has a pivoting groove 231 for connecting to an end of the actuating rod 50. The saddle set 30 has an upper saddle clamp 31 for assembling a saddle 32. The linkage arm set 40 a first arm 41 respectively pivoted onto a front end of the lower saddle clamp 31 and a front end of the lower assembling base 12, and a second arm 42 respectively pivoted onto a rear end of the lower saddle clamp 31 and a rear end the lower assembling base 12, to couple the lower saddle clamp 31 and the lower assembling base 12 via the first arm 41 and the second arm 42 and providing a containment space for the actuating rod 50. The actuating rod 50 has a first pivoting portion 51 and a second pivoting portion 52, the first pivoting portion 51 is inserted into the post member 11 and the pivoting groove 231 and pivoted with the piston pole 23, and the second pivoting portion 52 is pivoted with the lower saddle clamp 31 and the second arm 42.

In addition, the lower saddle clamp 31 is configured for coupling with the upper saddle clamp 33, such that the lower saddle clamp 31 and the upper saddle clamp 33 are capable of sandwiching a bearing axle 34 of the saddle 32, and a bottom portion of the upper saddle clamp 33 has a toothed surface 331 corresponding to a toothed surface 341 of the bearing axle 34.

Furthermore, the elastic member 22 is a compression spring.

Moreover, the actuating rod 50 is jacketed with a rubber sleeve 60 mounted onto the post member 11, for preventing direct impact between the actuating rod 50 and the post member 11 and dust invasion.

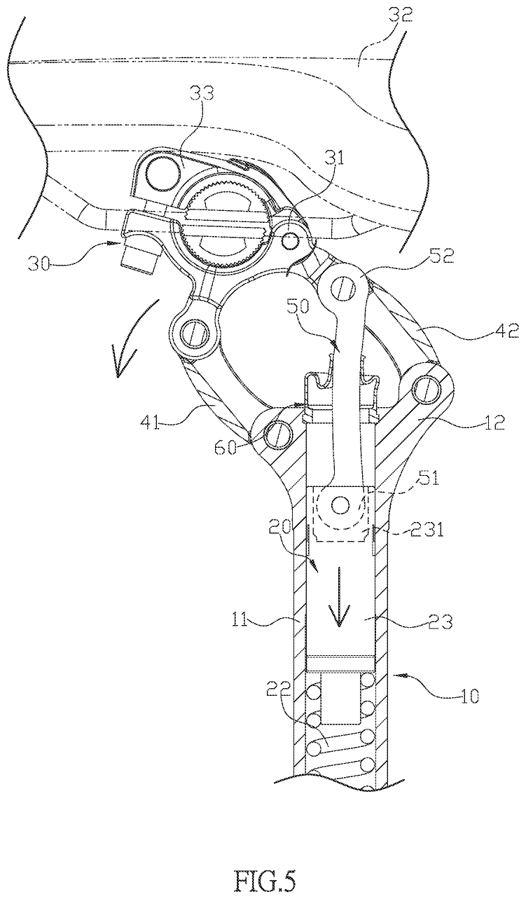

In actual operation, when the bicycle is travelling on an uneven road, the saddle 32 bears impact and drives the first arm 41 and the second arm 42 to produce a downward swing, as shown in FIG. 5, the actuating rod 50 pushes down the piston pole 23, so that the piston pole 23 moves closer to the top of the fixed pole 21 and compresses the elastic member 22. With the elastic force of the compressed elastic member 22, the impact caused by the vibration of the road surface can be offset and slowed down which makes the rider to be more comfortable while riding the bicycle and also avoids sports injuries.

Although the present invention has been explained in relation to its preferred embodiment, it is to be understood that many other possible modifications and variations can be made without departing from the spirit and scope of invention as hereinafter claimed.

What is claimed is:

1. A shock-absorbing tube structure for a bicycle seat comprising: a seat post, a shock-absorbing unit, a saddle set, a linkage arm set, and an actuating rod, wherein:
the seat post has a post member with a lower assembling base at a top end;
the shock-absorbing unit has a fixed pole lockable in the post member, an elastic member sleeved onto a free end of the fixed pole and sleeved onto a piston pole at another end, another end of the piston pole having a pivoting groove for connecting to an end of the actuating rod;
the saddle set has a lower saddle clamp for assembling a saddle;
the linkage arm set has a first arm respectively pivoted onto a front end of the lower saddle clamp and a front end of the lower assembling base, and a second arm respectively pivoted onto a rear end of the lower saddle clamp and a rear end of the lower assembling base, to couple the lower saddle clamp and the lower assembling base via the first arm and the second arm and providing a containment space for the actuating rod; and
the actuating rod has a first pivoting portion and a second pivoting portion, the first pivoting portion is inserted into the post member and the pivoting groove and pivoted with the piston pole, and the second pivoting portion is pivoted with the lower saddle clamp and the second arm.

2. The shock-absorbing tube structure for a bicycle seat as claimed in claim 1, wherein the lower saddle clamp is configured for coupling with an upper saddle clamp such that the lower saddle clamp and the upper saddle clamp are capable of sandwiching a bearing axle of the saddle, and a bottom portion of the upper saddle clamp has a toothed surface corresponding to a toothed surface of the bearing axle.

3. The shock-absorbing tube structure for a bicycle seat as claimed in claim 1, wherein the elastic member is a compression spring.

4. The shock-absorbing tube structure for a bicycle seat as claimed in claim 1, wherein the actuating rod is jacketed with a rubber sleeve mounted onto the post member, for preventing direct impact between the actuating rod and the post member and dust invasion.
